(19) United States
(12) Patent Application Publication
(10) Pub. No.: US 2025/0290442 A1
(43) Pub. Date: Sep. 18, 2025

(54) LOAD DEVICE ASSEMBLY, INTERNAL COMBUSTION ENGINE ASSEMBLY, AND VEHICLE

(71) Applicant: Isuzu Motors Limited, Yokohama-shi (JP)

(72) Inventor: Masao SATO, Fujisawa-shi (JP)

(73) Assignee: Isuzu Motors Limited, Yokohama-shi (JP)

(21) Appl. No.: 19/041,663

(22) Filed: Jan. 30, 2025

(30) Foreign Application Priority Data
Mar. 15, 2024 (JP) 2024-041597

(51) Int. Cl. F02B 67/04

(52) U.S. Cl. CPC F02B 67/04

(57) ABSTRACT

A load device assembly includes: an idle gear rotating in conjunction with rotation of a power gear of the internal combustion engine; a driven gear rotating by receiving a rotational force of the power gear via the idle gear, the idle gear disposed between the driven gear and the power gear; and a load device rotating integrally with the driven gear. As compared with first inertia by a first mass at least necessary for rotating a shaft to serve as a load of the power gear, inertia of the driven gear and the shaft is set as the second inertia larger than the first inertia, the second inertia is made larger to approach inertia of the power gear. The idle gear includes openings. Third inertia due to rotation of the idle gear is decreased as compared with fourth inertia in a case where the openings are not provided.

### CROSS REFERENCE TO RELATED APPLICATIONS

This application is based upon and claims the benefit of priority from prior Japanese Patent Application No. 2024-041597, filed Mar. 15, 2024, the entire contents of which are incorporated herein by reference.

### FIELD

The present invention relates to a load device assembly, an internal combustion engine assembly, and a vehicle.

### BACKGROUND

A load device such as an air compressor is driven in conjunction with a driving force by which a crankshaft of an internal combustion engine is rotated. Such a load device can be a load of rotation of the crankshaft of the internal combustion engine. For example, Jpn. Pat. Appln. KOKAI Publication No. 2020-45890 discloses a gear for a camshaft drive mechanism of an internal combustion engine.

### SUMMARY

According to an aspect of the present invention, there is provided a load device assembly for use with an internal combustion engine. The load device assembly includes: an idle gear that is configured to rotate in conjunction with rotation of a power gear of the internal combustion engine; a driven gear that is configured to rotate by receiving a rotational force of the power gear via the idle gear, the idle gear being disposed between the driven gear and the power gear; and a load device that is configured to rotate integrally with the driven gear and that includes a shaft to serve as a load of the power gear. As compared with first inertia by a first mass obtained by combining the driven gear and the shaft at least necessary for rotating the shaft of the load device, inertia of the driven gear and the shaft is set as second inertia larger than the first inertia, the second inertia is made larger to approach inertia of the power gear, the idle gear includes a plurality of openings, and third inertia due to rotation of the idle gear is decreased as compared with fourth inertia in a case where the plurality of openings is not provided.

### BRIEF DESCRIPTION OF THE DRAWINGS

FIG. 1 is a schematic diagram illustrating a vehicle including an internal combustion engine assembly having a load device assembly and an internal combustion engine serving as a power source for driving a load device of the load device assembly according to an embodiment.

FIG. 2 is a schematic view illustrating a positional relationship between a power gear of the internal combustion engine and the load device (air compressor) of the load device assembly and illustrating an arrangement of the power gear of the internal combustion engine, a driven gear fixed to a crankshaft of the air compressor, and an idle gear between the power gear and the driven gear of the air compressor.

FIG. 3 is a schematic front view of the idle gear according to the embodiment.

FIG. 4 is a schematic view illustrating the driven gear and the load device (air compressor) of the load device assembly according to the embodiment.

FIG. 5 is a schematic view illustrating the crankshaft of the load device (air compressor) according to the embodiment.

FIG. 6 is a schematic view illustrating a crankshaft of a load device (air compressor) according to a comparative example.

### DETAILED DESCRIPTION

Hereinafter, a load device assembly 22 of an internal combustion engine assembly 12 of a vehicle 10 according to the present embodiment will be described with reference to the drawings. A relative size of each member in each drawing is schematic, and may be different from an actual size.

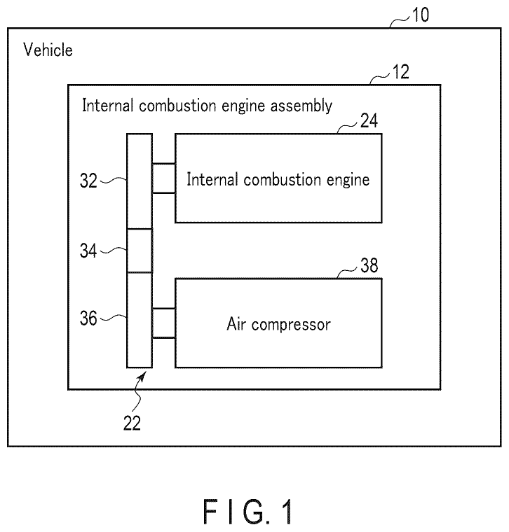

As illustrated in FIG. 1, the vehicle 10 has the internal combustion engine assembly 12. The internal combustion engine assembly 12 includes the load device assembly 22 and an internal combustion engine 24 serving as a power source configured to drive the load device assembly 22. An example of the vehicle 10 is a truck, a tractor, or the like.

The internal combustion engine 24 is, for example, a diesel engine or the like.

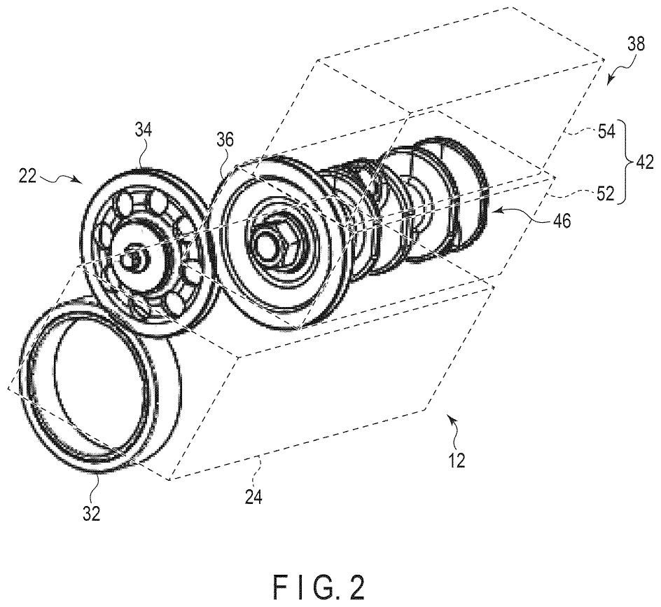

As illustrated in FIG. 2, the load device assembly 22 is disposed on a power gear 32 such as a crankshaft sprocket of the internal combustion engine 24. The load device assembly 22 includes an idle gear 34 that rotates in conjunction with rotation of the power gear 32, a driven gear 36 to which power from the power gear 32 is transmitted via the idle gear 34, and an air compressor 38 as a load device to which the driven gear 36 is fixed and which is operated by the rotation of the driven gear 36.

Here, an example of the air compressor 38 will be described as the load device, but in a case where a rotary assembly body rotated by the power gear 32 via the idle gear 34 is rotated, the rotary assembly body can be the load device.

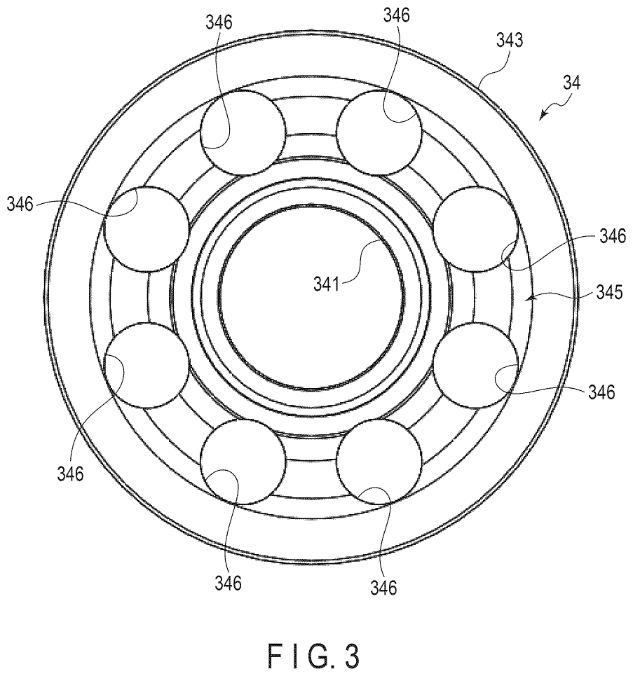

The idle gear 34 is used as an intermediate gear between the power gear 32 and the driven gear 36. As illustrated in FIGS. 2 and 3, the idle gear 34 includes a cylindrical boss portion 341 disposed at a center portion, a tooth portion 343 disposed at an outer peripheral portion, and a coupling portion 345 coupling the tooth portion 343 and the boss portion 341.

As illustrated in FIG. 2, the boss portion 341 is rotatably supported by, for example, the internal combustion engine 24.

As illustrated in FIGS. 2 and 3, the tooth portion 343 is formed as an outer peripheral tooth. The tooth portion 343 is formed as, for example, a helical gear, and is meshed with the power gear 32 and the driven gear 36 serving as mating gears. Note that the tooth portion 343 of the idle gear 34 may be formed as another type of gear, for example, a spur gear.

The coupling portion 345 is formed in a disk ring shape. The coupling portion 345 includes a plurality of holes or a plurality of openings 346 at equal intervals in a circumferential direction. The plurality of holes 346 is, for example, circular shapes having the same diameter. A distance between each hole (for example, circular hole) 346 of the coupling portion 345 and a central axis of the idle gear 34 is the same. Then, a distance between each hole 346 and an inner peripheral edge of the boss portion 341 of the idle gear 34 is longer than a distance between each hole 346 and an outer peripheral edge of the idle gear 34. Therefore, each hole 346 is provided on an outer peripheral edge (tooth portion 343) side of the coupling portion 345 of the idle gear 34.

Note that the plurality of holes 346 may or may not be circular as described above. The plurality of holes 346 is favorably formed symmetrically with respect to an imaginary radial axis (imaginary line) extending in a radial direction from a center of the idle gear 34.

Then, in such an idle gear 34, inertia (third inertia) due to the rotation of the idle gear 34 is made lower than inertia (fourth inertia) in a case where the plurality of holes (openings) 346 is not provided. That is, the idle gear 34 can reduce a moment of inertia of the idle gear 34 by arranging the plurality of holes 346 as close as possible to the tooth portion 343.

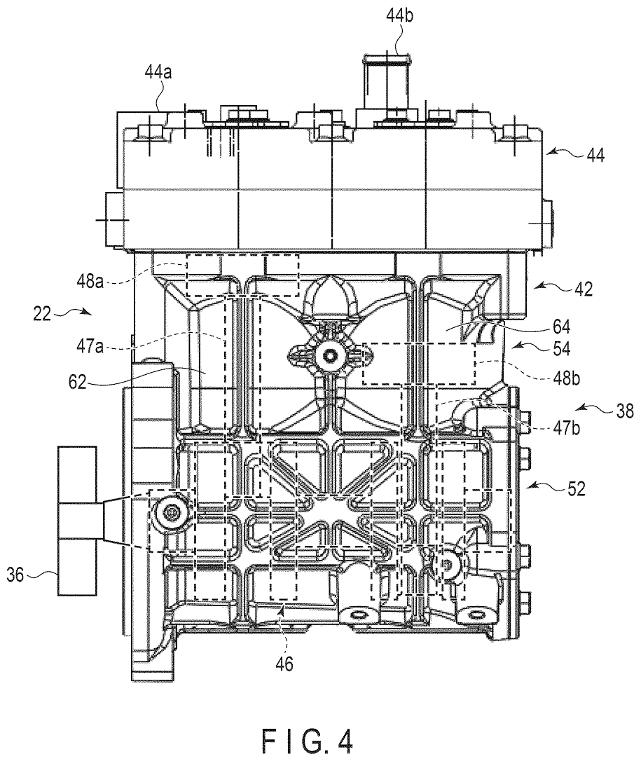

As illustrated in FIG. 4, here, the driven gear 36 is fixed to a shaft (crankshaft) 46 described below of the air compressor 38 to form the integrated rotary assembly body. That is, the shaft 46 integrally rotates with the driven gear 36 along with the rotation of the driven gear 36, and becomes a load of the power gear 32.

The driven gear 36 has the idle gear 34 disposed between the driven gear 36 and the power gear 32, and is rotated by receiving a rotational force of the power gear 32 via the idle gear 34.

The air compressor 38 as an example of the load device illustrated in FIG. 4 will be described as two cylinders (two piston chambers) in the present embodiment. The air compressor 38 may be a single cylinder or multi-cylinders such as three or more cylinders (piston chambers).

The air compressor 38 includes a cylinder block 42 that includes a crankcase 52 and a cylinder portion 54 of a plurality of cylinders, a cylinder head 44 that covers the cylinder portion 54 of the cylinder block 42, the crankshaft 46 that is supported in the crankcase 52, and pistons 48a and 48b that is configured to reciprocate in the cylinder portion 54 by the crankshaft 46, take in air from an outside of the air compressor 38, compress the taken air, and discharge the compressed air to the outside of the air compressor 38.

The cylinder block 42 and the cylinder head 44 are each formed of, for example, cast iron.

The cylinder head 44 is provided with an air suction port 44a and an air discharge port 44b. The air suction port 44a is formed as an opening for taking in air into the air compressor 38. An air tank (not illustrated) is connected to the air discharge port 44b. Compressed air compressed using the pistons 48a and 48b in the air compressor 38 is discharged through the air discharge port 44b and stored in the air tank.

FIG. 4 illustrates the cylinder block 42. The crankcase 52 illustrated in FIG. 4 is formed in a substantially cylindrical shape in order to rotate the crankshaft 46 about a central axis C of a main shaft 46a and a main journal 46b in the crankcase 52.

The cylinder portion 54 is provided so as to protrude in a radial direction with respect to the crankcase 52. In the cylinder portion 54, a first cylinder portion 62 and a second cylinder portion 64 are arranged along an axial direction of the crankshaft 46. An axial direction of the first cylinder portion 62 and an axial direction of the second cylinder portion 64 intersect with the axial direction of the crankshaft 46. It is preferably that the axial directions of the first cylinder portion 62 and the second cylinder portion 64 are parallel.

The first piston 48a is disposed in the first cylinder portion 62, and a first connecting rod 47a is disposed between the crankshaft 46 and the first piston 48a. The second piston 48b is disposed in the second cylinder portion 64, and the second connecting rod 47b is disposed between the crankshaft 46 and the second piston 48b. Note that the first piston 48a and the second piston 48b are favorably formed in a bottomed cylindrical shape, for example, and a bottom side is disposed on a side of the cylinder head 44.

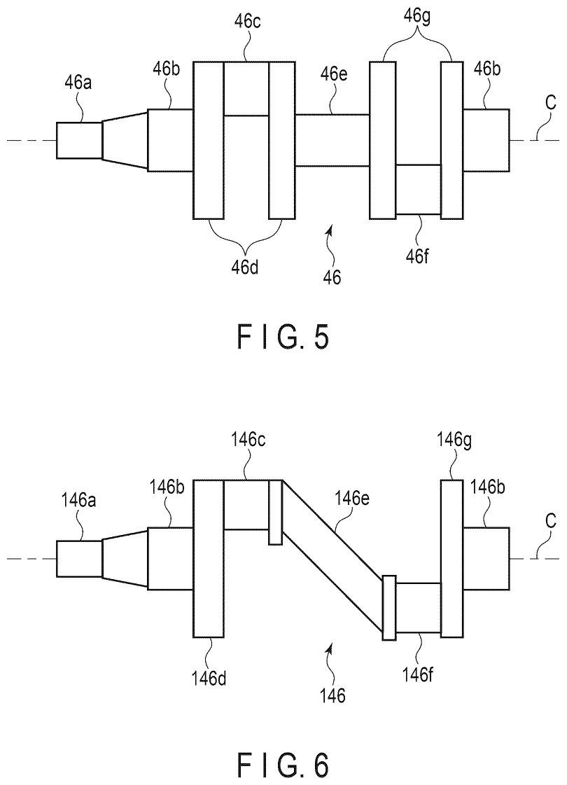

Hereinafter, a case where the air compressor 38 uses the crankshaft 46 according to the present embodiment illustrated in FIG. 5 will be described while being compared with a case where the air compressor 38 uses a crankshaft 146 according to a comparative example illustrated in FIG. 6.

In the present embodiment, the air compressor 38 according to the present embodiment is assumed to use the crankshaft 46 illustrated in FIG. 5.

Note that FIG. 6 illustrates the crankshaft 146 according to the comparative example. The crankshaft 146 according to the comparative example is assumed to have, for example, mass close to the minimum required for appropriately moving the first piston 48a up and down in the first cylinder portion 62 and appropriately moving the second piston 48b up and down in the second cylinder portion 64. The crankshaft 146 is provided with a moment of inertia close to the minimum required for appropriately moving the first piston 48a up and down in the first cylinder portion 62 and appropriately moving the second piston 48b up and down in the second cylinder portion 64. That is, the crankshaft 146 according to the comparative example is formed to appropriately move the pistons 48a and 48b and discharge the compressed air.

As illustrated in FIG. 5, the crankshaft 46 includes the main shaft 46a, the main journal 46b, a first crank pin 46c, first counterweights 46d, a coupling portion 46e, a second crank pin 46f, and second counterweights 46g.

The first crank pin 46c is disposed between the first counterweights 46d. A central axis of the first crank pin 46c is shifted from the central axis C of the main shaft 46a and the main journal 46b. The first crank pin 46c is coupled to one end of a first connecting rod 47a (see FIG. 4).

The second crank pin 46f is disposed between the second counterweights 46g. A central axis of the second crank pin 46f is shifted from the central axis C of the main shaft 46a and the main journal 46b. The second crank pin 46f is coupled to one end of a second connecting rod 47b (see FIG. 4).

The central axis of the first crank pin 46c and the central axis of the second crank pin 46f are shifted by, for example, 180° with respect to the central axis C of the main shaft 46a and the main journal 46b.

In the present embodiment, a central axis of the coupling portion 46e coincides with the central axis C of the main shaft 46a and the main journal 46b.

An example of the mass of the crankshaft 46 of the present embodiment illustrated in FIG. 5 is 4407 g. Then, a moment of inertia (second inertia) of the rotary assembly body including the driven gear 36 and the crankshaft 46 is, for example, 4246.4 kg·m². The moment of inertia (second inertia) of the rotary assembly body is smaller than the moment of inertia of the power gear 32. The crankshaft 146 according to the comparative example illustrated in FIG. 6 includes a main shaft 146a, a main journal 146b, a first crank pin 146c, a first counterweight 146d, a coupling portion 146e, a second crank pin 146f, and a second counterweight 146g.

The first crank pin 146c is disposed between the first counterweight 146d and the coupling portion 146e. A central axis of the first crank pin 146c is shifted from the central axis C of the main shaft 146a and the main journal 146b. The first crank pin 146c is coupled to one end of the first connecting rod 47a (see FIG. 4).

The second crank pin 146f is disposed between the second counterweight 146g and the coupling portion 146e. A central axis of the second crank pin 146f is shifted from the central axis C of the main shaft 146a and the main journal 146b. The second crank pin 146f is coupled to one end of the second connecting rod 47b (see FIG. 4).

The central axis of the first crank pin 146c and the central axis of the second crank pin 146f are shifted by, for example, 180° with respect to the central axis C of the main shaft 146a and the main journal 146b.

In the comparative example, the coupling portion 146e couples the first crank pin 146c and the second crank pin 146f. Therefore, a central axis of the coupling portion 146e is inclined with respect to the central axis C of the main shaft 46a and the main journal 46b.

An example of the mass of the crankshaft 146 of the comparative example illustrated in FIG. 6 is 2690 g. Then, a moment of inertia (first inertia) of the rotary assembly body including the driven gear 36 and the crankshaft 146 is, for example, 2005.6 kg·m².

Therefore, the crankshaft 46 according to the present embodiment has the mass larger by 1717 g than the crankshaft 146 according to the comparative example. The crankshaft 46 according to the present embodiment has the counterweights 46d and 46g having large mass, and has greatly larger mass than the crankshaft 146 according to the comparative example. Therefore, the mass of the driven crankshaft 46 according to the present embodiment is made larger than the mass of the crankshaft 146 that can appropriately move the pistons 48a and 48b.

Further, the moment of inertia of the driven gear 36 and the crankshaft 46 according to the present embodiment is also made larger by 2240.8 kg·m² than that of the driven gear 36 and the crankshaft 146 according to the comparative example. Therefore, the moment of inertia of the driven gear 36 and the crankshaft 46 that are driven according to the present embodiment is made twice or more larger than the moment of inertia of the driven gear 36 and the crankshaft 146 that can appropriately move the pistons 48a and 48b.

Therefore, the rotary assembly body including the crankshaft 146 and the driven gear 36 according to the comparative example is rotated with a relatively light force from the power gear 32 via the idle gear 34.

Note that, for example, the second inertia (moment of inertia) of the rotary assembly body in which the driven gear 36 for rotating the crankshaft 46 of the present embodiment and the crankshaft 46 are integrated is made larger than the first inertia (moment of inertia) by first mass of the rotary assembly body in which the driven gear 36 and the crankshaft 146 of the comparative example are integrated, the first inertia being at least necessary for rotating the crankshaft 146 of the load device 38 of the comparative example. Therefore, the second inertia of the rotary assembly body in which the driven gear 36 according to the present embodiment and the crankshaft 46 according to the present embodiment are integrated is made closer to the inertia of the power gear 32 than in the comparative example.

In general, the internal combustion engine assembly 12 causes the crankshaft 46 of the air compressor 38 as the load device to be rotated by the power of the power gear 32 of the internal combustion engine 24 via the idle gear 34 and the driven gear 36, and causes the air compressor 38 to exhibit the function to repeatedly take in air and discharge compressed air while moving the pistons 48a and 48b up and down. Therefore, to suppress the load on the power gear 32 of the internal combustion engine 24, it is considered favorable to reduce the mass of the crankshaft 146 and the moment of inertia as in the comparative example.

However, it has been found that, in the load device assembly 22, in a case where the mass and the moment of inertia of the idle gear 34 are reduced by the plurality of holes 346 illustrated in FIG. 3, and an assembly body rotated with a relatively light force such as the driven gear 36 and the crankshaft 146 of the comparative example is used, a rattling sound between the idle gear 34 and the driven gear 36 may not be suppressed well. Meanwhile, the inventor of the present application has found that, in the load device assembly 22, in a case where a rotary assembly body rotated with a relatively large inertial force such as the driven gear 36 and the crankshaft 46 of the present embodiment is used while reducing the mass and the moment of inertia of the idle gear 34 by the plurality of holes 346 and the like illustrated in FIG. 3, the rattling sound between the idle gear 34 and the driven gear 36 is suppressed.

Therefore, in the load device assembly 22 according to the present embodiment, the mass and the moment of inertia of the rotary assembly body of the driven gear 36 and the crankshaft 46 are made relatively larger than those of the comparative example. Therefore, once the assembly body of the driven gear 36 and the crankshaft 46 (see FIG. 4) starts to rotate, it is possible to suppress the inertial force of the assembly body from acting in a stationary direction. That is, since the mass and the moment of inertia of the assembly body of the driven gear 36 and the crankshaft 46 are made relatively large, a load is applied to the start of the movement of the assembly body of the driven gear 36 and the crankshaft 46, but after the start of the movement, the inertia force is suppressed from acting in the direction in which the assembly body of the driven gear 36 and the crankshaft 46 is stopped.

Therefore, in the load device assembly 22 according to the present embodiment, the second inertia larger than the first inertia for rotating the rotary assembly body is made larger so as to approach the inertia of power gear 32 as compared with the first inertia by the first mass at least necessary for rotating the rotary assembly body in which driven gear 36 and shaft 46 are integrated, that is, for exerting the function of the load device 38. Further, in the load device assembly 22 according to the present embodiment, the idle gear 34 includes the plurality of openings 346, and the third inertia caused by the rotation of idle gear 34 is lowered as compared with the fourth inertia in the case where the plurality of openings 346 is not provided. Therefore, according to the present embodiment, it is possible to provide the load device assembly 22 capable of suppressing the gear rattle between the idle gear 34 and the driven gear 36 of the load device 38, the internal combustion engine assembly 12 including the load device assembly 22, and the vehicle 10 including the internal combustion engine assembly 12.

In the present embodiment, an example in which the mass and the moment of inertia of the crankshaft 46 are made large has been described. Although not described in detail, by making the mass and the moment of inertia of the driven gear 36 large, it is also possible to provide the load device assembly 22 capable of suppressing the gear rattle between the idle gear 34 and the driven gear 36 of the load device 38, the internal combustion engine assembly 12 including the load device assembly 22, and the vehicle 10 including the internal combustion engine assembly 12.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A load device assembly for use with an internal combustion engine, the load device assembly comprising:
an idle gear that is configured to rotate in conjunction with rotation of a power gear of the internal combustion engine;
a driven gear that is configured to rotate by receiving a rotational force of the power gear via the idle gear, the idle gear being disposed between the driven gear and the power gear; and
a load device that is configured to rotate integrally with the driven gear and that includes a shaft to serve as a load of the power gear,
wherein:
as compared with first inertia by a first mass obtained by combining the driven gear and the shaft at least necessary for rotating the shaft of the load device, inertia of the driven gear and the shaft is set as second inertia larger than the first inertia, the second inertia is made larger to approach inertia of the power gear,
the idle gear includes a plurality of openings, and
third inertia due to rotation of the idle gear is decreased as compared with fourth inertia in a case where the plurality of openings is not provided.

2. The load device assembly according to claim 1, wherein:
the shaft is a crankshaft, and
the second inertia is twice or more the first inertia.

3. The load device assembly according to claim 2, wherein:
the load device is an air compressor that is configured to discharge compressed air by rotation of the crankshaft.

4. The load device assembly according to claim 1, wherein:
the plurality of openings is formed symmetrically with respect to an imaginary line extending in a radial direction from a central axis of the idle gear at equal intervals in a circumferential direction, and
distances between a center of the idle gear and the plurality of openings are the same.

5. The load device assembly according to claim 1, wherein:
in a case where the plurality of openings is circles having the same diameter, a distance between the plurality of openings and an inner peripheral edge of the idle gear is longer than a distance between the plurality of openings and an outer peripheral edge of the idle gear.

6. An internal combustion engine assembly comprising:
the load device assembly according to claim 1;
the power gear; and
an internal combustion engine that applies power to the power gear.

7. A vehicle comprising: the internal combustion engine assembly according to claim 6.
